(19) United States
(12) Patent Application Publication
(10) Pub. No.: US 2016/0337806 A1
(43) Pub. Date: Nov. 17, 2016

(54) Method of Location Based Electronic Document Signature Tracking by Executing Computer-Executable Instructions Stored On a Non-Transitory Computer-Readable Medium

(71) Applicants: Ronald C. Schurr, Citrus Heights, CA (US); Maurice A. Brown, Elk Grove, CA (US)

(72) Inventors: Ronald C. Schurr, Citrus Heights, CA (US); Maurice A. Brown, Elk Grove, CA (US)

(21) Appl. No.: 15/156,314

(22) Filed: May 16, 2016

Related U.S. Application Data
(60) Provisional application No. 62/161,464, filed on May 14, 2015.

(51) Int. Cl. H04W 4/02; G06F 3/0484; G06F 3/0482; G06F 3/0488; G06F 17/30; G06F 17/24

(52) U.S. Cl. CPC H04W 4/025; G06F 17/30241; G06F 17/30011; G06F 17/24; G06F 3/0482; G06F 3/04883; G06F 3/0484

(57) ABSTRACT

A method of location based electronic document signature tracking provides the ability to track electronically signed documents by location. An electronic document is received on a mobile GPS-enabled device, the electronic document is opened with document reader software, and a user enters signature input through a signature input field, either as a freehand, drawn signature, or as a typed text signature rendered into a font. A location signed document is created by associating the signature input and a location indicator retrieved from the mobile device's GPS device, and stored in a database, from where the location signed document can be retrieved and viewed along with the document's signature coordinates.

The current application claims a priority to the U.S. Provisional Patent application Ser. No. 62/161,464 filed on May 14, 2015. The current application is filed on May 16, 2016, whereas May 14, 2016 and May 15, 2016 were on a weekend.

### FIELD OF THE INVENTION

The present invention relates generally to documents. More particularly, the present invention relates to geographically tracking signatures on electronic documents.

### BACKGROUND OF THE INVENTION

Currently, location tracking is being used in a variety of applications such as phone calls, any instant messaging, IP (internet protocol) address technology—which is currently an unreliable source due to technologies that can spoof an IP address location, and even various apps. The location of a user is very important to their family, friends, and business associates. Signatures are a tremendously large part of business and legal transactions, and electronic signatures are being increasingly utilized. It would be very useful for location tracking to be integrated into electronic signatures.

The present invention provides accurate and real time connectivity via geo-location based coordinates of any and all digital signature and/or electronic signature performed on the smartphone, smartwatch and tablet computing devices such as laptops, notebooks and other GPS enabled handheld mobile applications with built in location-based services for better tracking of where and what time the signature took place whether discernible or indiscernible to the human eye. The present invention does not discriminate if the document is watermarked or if it is a secured document as the present invention only acknowledges if the PDF and other widely used file name extensions and commonly used document formats such as Excel, PowerPoint, Word, etc. and/or compatible electronic forms was signed digitally and/or electronically at the place of specified origin.

### BRIEF DESCRIPTION OF THE DRAWINGS

FIG. 1 is an overview of one example of a system for facilitating the present invention.

FIG. 2 is a broad overview of the present invention.

FIG. 3 is a stepwise flow diagram showing the steps of the general method of the present invention.

FIG. 4 is a stepwise flow diagram showing steps for designating the location indicator and metadata for an electronic document.

FIG. 5 is a stepwise flow diagram showing steps for displaying electronic documents and receiving signature input.

FIG. 6 is a stepwise flow diagram showing further steps for displaying the location indicator and signed documents.

FIG. 7 is an illustration of a mobile device prompting to permit access to the GPS device.

FIG. 8 is an illustration of a mobile device showing an electronic document ready to be signed.

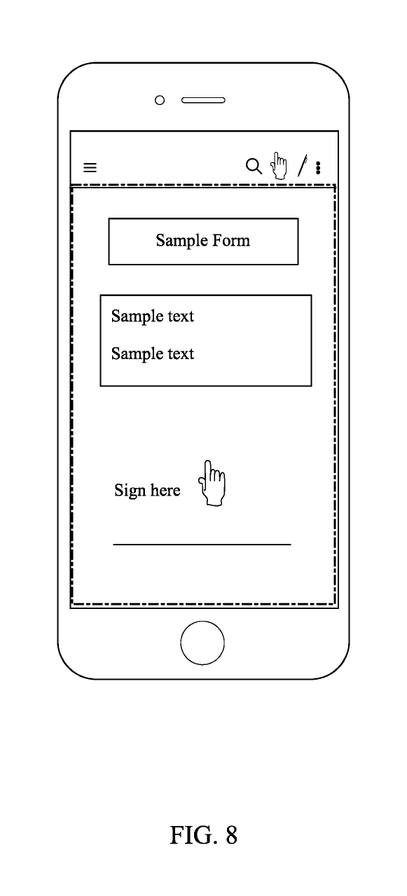

FIG. 9 is an illustration of a drawn signature input on a mobile device.

FIG. 10 is an illustration of a mobile device showing a signed electronic document with a drawn signature.

FIG. 11 is an illustration of a mobile device showing a signed electronic document with a typed signature.

FIG. 12 is an illustration of a mobile device showing a list of electronic documents.

FIG. 13 is an illustration of a mobile device showing a location marker on a map interface.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

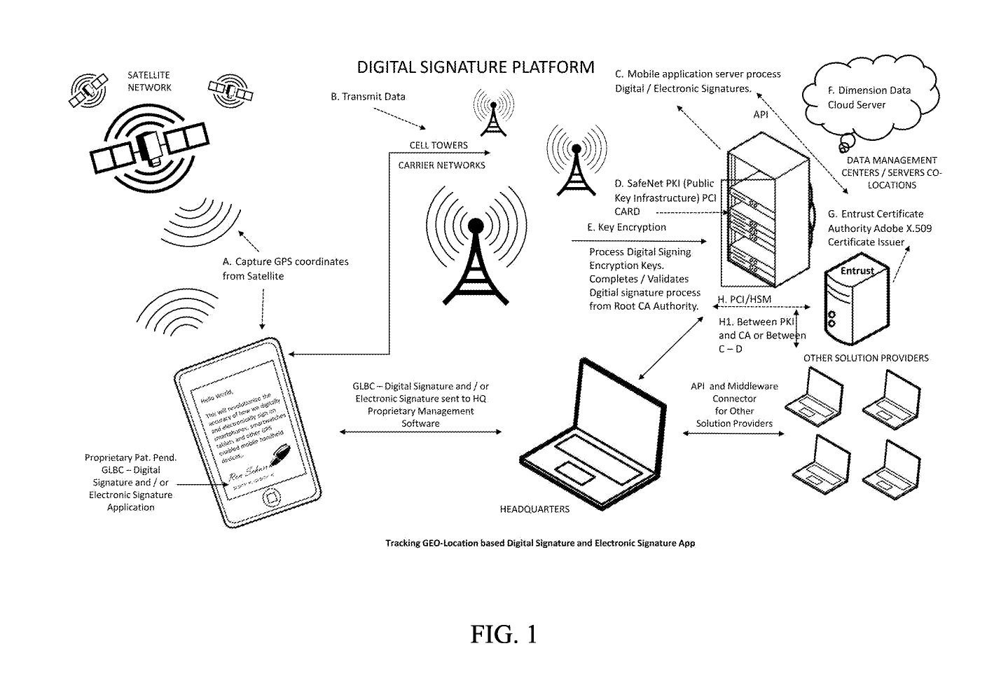

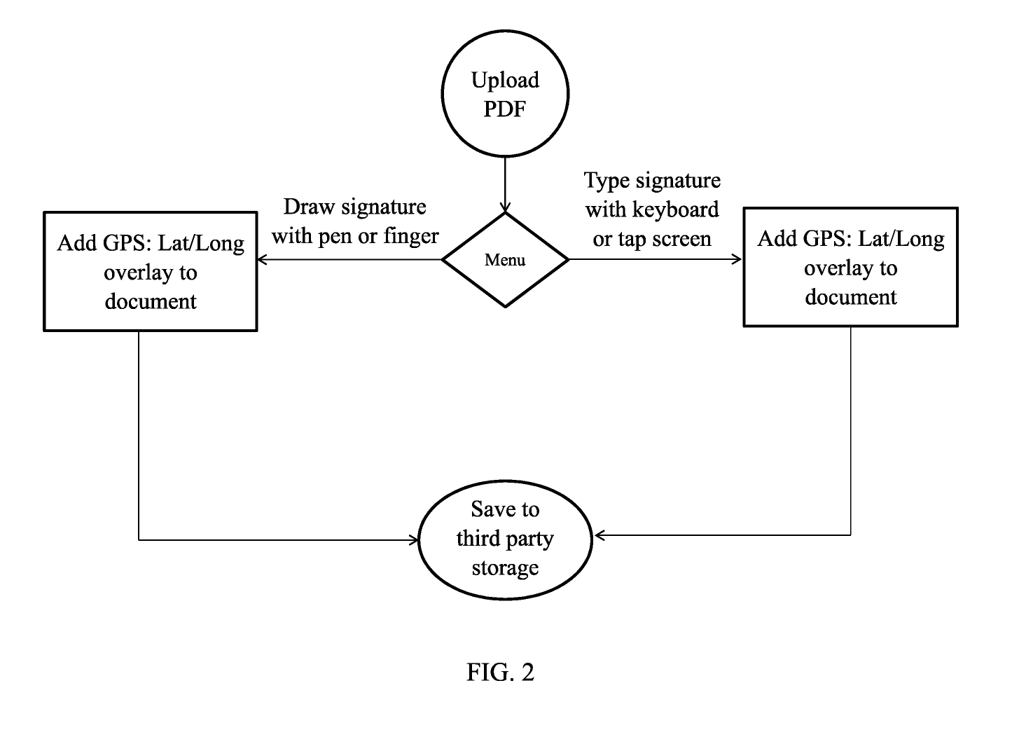

The present invention is a method of location based electronic document signature tracking, providing the ability to track electronic document signatures by geographical location. More particularly, in one embodiment the present invention is a mobile software application that is operated on a mobile computing device, such as, but not limited to, a smart cellular phone, a tablet, a laptop computer, or any other relevant and useful type of mobile computing device. The present invention is performed through execution of computer-executable instructions stored on one or more non-transitory computer-readable mediums, such as, but not limited to, hard disk drives (HDDs), solid state drives (SSDs), along with any other electronic circuitry and processing components necessary to facilitate the present invention. It should be noted that except for references to physical electronic circuitry, the words “digital” and “electronic” will be used interchangeably, as any executable programming action or file is technically both digital: “of, relating to, or being data in the form of especially binary digits (digital images) (a digital readout)” and electronic: “operating through the use of many small electrical parts (such as microchips and transistors).” A general overview of a system for facilitating the present invention is shown in FIG. 1, and a general depiction of the process of the present invention is shown in FIG. 2.

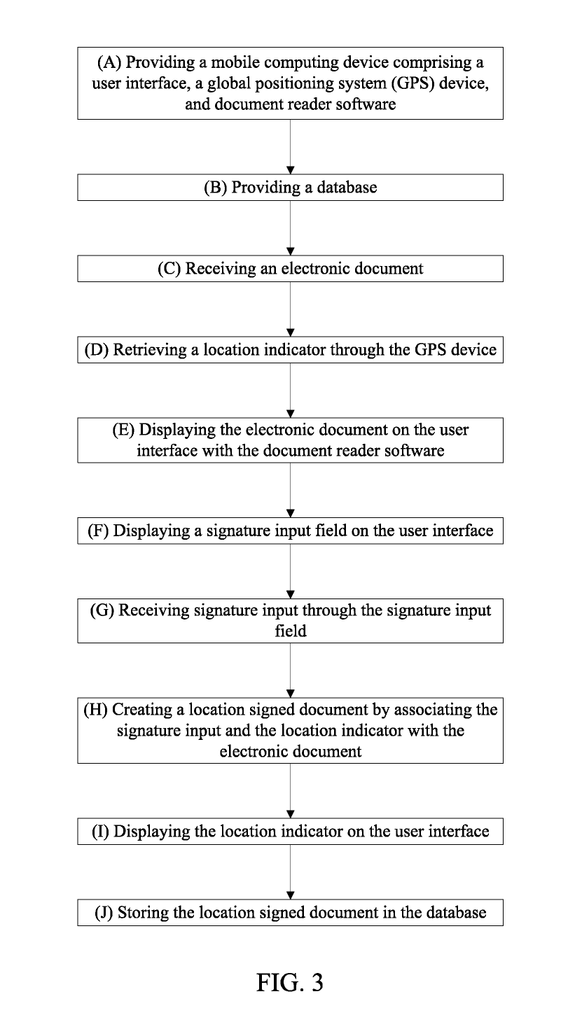

Referring to FIG. 3, in the method of the present invention, a database and a mobile computing device are provided, the mobile computing device comprising a user interface, a global positioning system (GPS) device, and document reader software. In one embodiments, the user interface is a touchscreen. In other embodiments, the user interface is a non-touch digital display and one or more input devices such as, but not limited to, a keyboard, mouse, or other input devices. The GPS device is any currently known or future circuitry and/or other hardware necessary to communicate with GPS satellites in order to ascertain the current geographical location of the mobile computing device associated with the GPS device. The document reader software is any software that is able to open and display any relevant document type, such as, but not limited to, portable document format (PDF) documents, Microsoft Word documents, Microsoft Excel documents, or any other type of document that is able to facilitate electronic signatures. The mobile computing device should furthermore have a cellular network chipset facilitating wireless electronic communication with a database, and/or a server or other remote computing system components over a cellular network. It is contemplated, however, that another type of wireless communication device such as, but not limited to, a Bluetooth chipset, or a Wi-Fi chipset, may be additionally or alternatively utilized in some manner to communicate with the database and/or server.

To initiate the process of the present invention, an electronic document is received for the purpose of attaching an electronic signature to the electronic document. The electronic document may be uploaded to the database and transmitted to the mobile device through the cellular network or other data transfer means, or the electronic document may be transferred directly to the mobile device through a portable storage device, a data transfer cable, a local Bluetooth or Wi-Fi connection, or through other means.

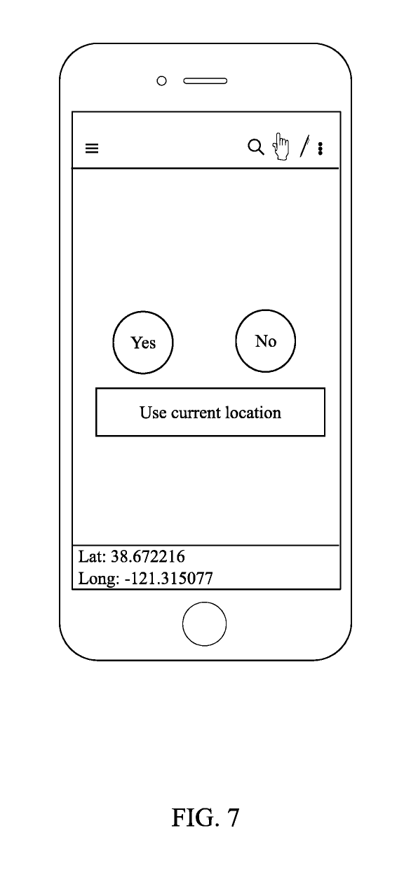

A location indicator is retrieved through the GPS device. When the location indicator is retrieved is not of particular importance, so long as the location indicator is retrieved before the document signing process is finalized. As illustrated in FIG. 7, in various embodiments, the user is prompted through the user interface to allow access to the GPS device, and the location indicator is subsequently retrieved from the GPS device if user input is received through the user interface to allow access to the GPS device.

The electronic document is displayed on the user interface with the document reader software, and a signature input is also displayed on the user interface. In one embodiment, a signature initiation icon, button or other type of indicator is displayed on the user interface, which the user must select through the user interface in order to initiate the signature input. In other embodiments, the signature input is always displayed on the user interface along with or within the electronic document.

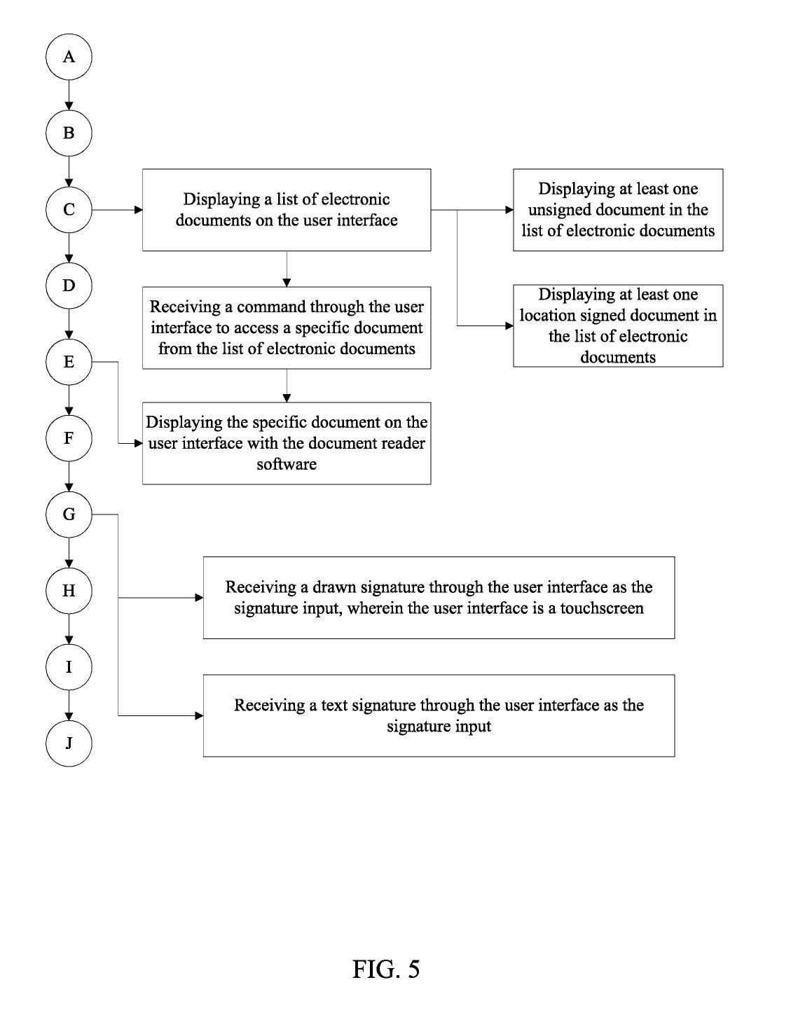

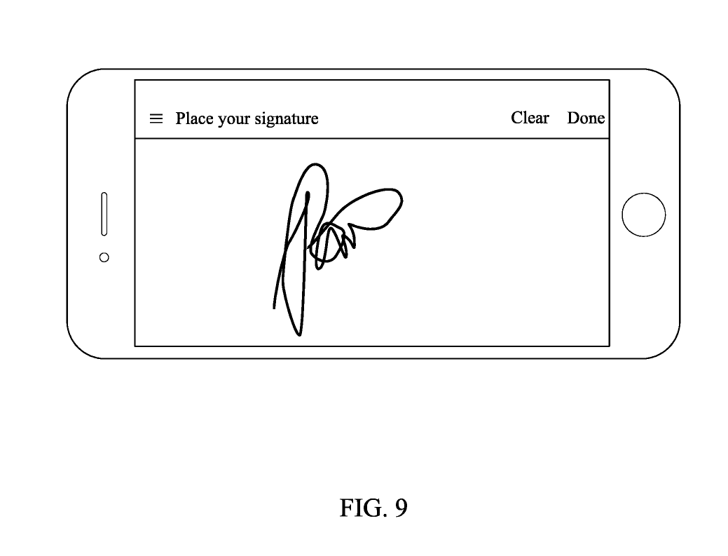

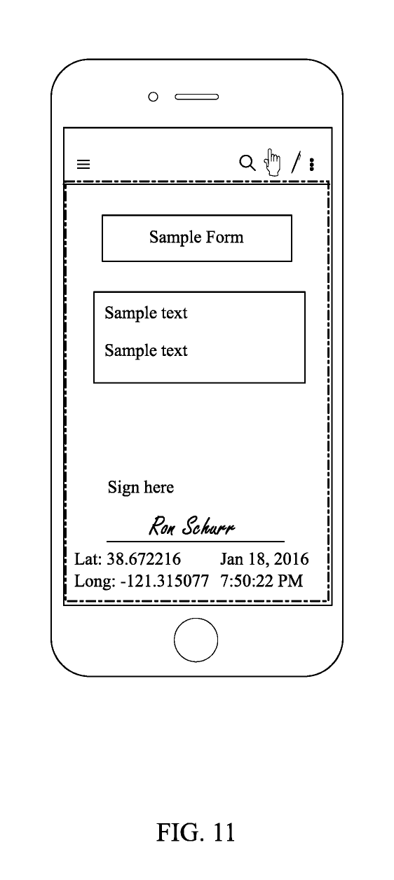

Signature input is then received through the signature input field on the user interface. The signature input may be any type of signature. Referring to FIGS. 5, 9 and 10, in one embodiment, the signature input is a drawn signature through a touchscreen as the user interface, the signature input being drawn using a stylus, finger or other touchscreen compatible input means. Referring to FIG. 11, in one embodiment, the signature input is a text signature which is typed by the user using any type of keyboard interface or another means of inputting text that results in a rendered font or typeface.

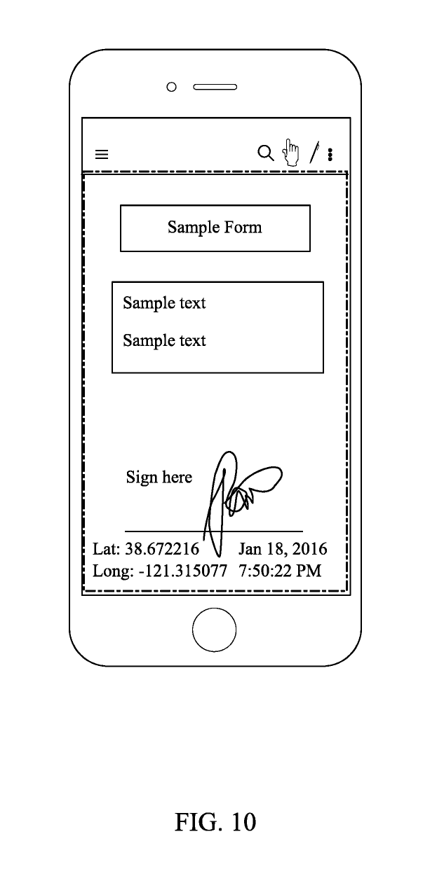

After the signature input is received, the user activates a button or other type of input on the user interface, indicating that input of the signature is complete. Then, a location signed document is created by associating the signature input and the location indicator with the electronic document. Referring to FIGS. 10-11, in one embodiment, the signature input is rendered or otherwise displayed on the electronic document in a location designated by the user through the user interface. For example, in one embodiment, after the signature input is received, the signature is displayed on the electronic document, and the user may manually place the signature input by dragging or otherwise indicating a desired position for the signature input on the electronic document. In another embodiment, the user may choose from one or more designated signature locations on the electronic document. In another embodiment, the signature input is automatically placed in a pre-determined location. Some electronic documents may have multiple signature fields, so the signing process must be executed as many times as the number of signature fields in order to completely sign the electronic document. It is contemplated that in some embodiments, multiple signatures on a single electronic document may be required from multiple different users utilizing the present invention. After the location signed document is created, the location indicator is displayed on the user interface, and the location signed document is stored in the database.

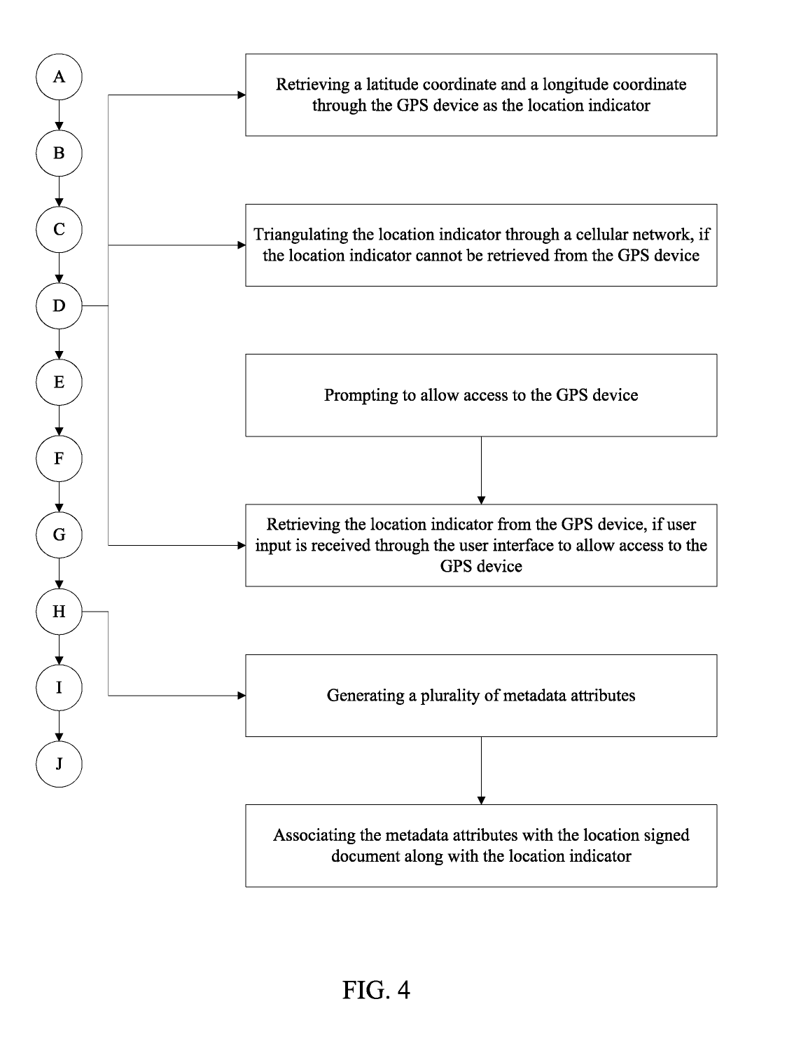

Referring to FIG. 4, in one embodiment, the location indicator is retrieved through the GPS device as a latitude coordinate and a longitude coordinate. In one embodiment, the location indicator is retrieved by triangulating the location indicator through a cellular network, if the location indicator cannot be retrieved from the GPS device. It is contemplated that various embodiments may utilize the GPS coordinates, triangulation through a cellular network or other wireless network, and/or ascertaining the location indicator through an internet protocol (IP) address through connection to a Wi-Fi network, or other means, in any various combinations for redundancy, failover, accuracy and other purposes. However, it should be noted that using GPS coordinates is the preferred means of specifying the location indicator in the present invention, as the aforementioned other methods are generally much less accurate than GPS coordinates.

In one embodiment, a plurality of metadata attributes is generated for the location signed document, and the plurality of metadata attributes is associated within the location signed document along with the location indicator. In one embodiment, the location indicator is one of the plurality of metadata attributes. In one embodiment, the location indicator is separate from the plurality of metadata attributes. The plurality of metadata attributes may include, but are not limited to, date and time created, date and time modified, author, document type, file size, one or more keywords, or other types of metadata attributes.

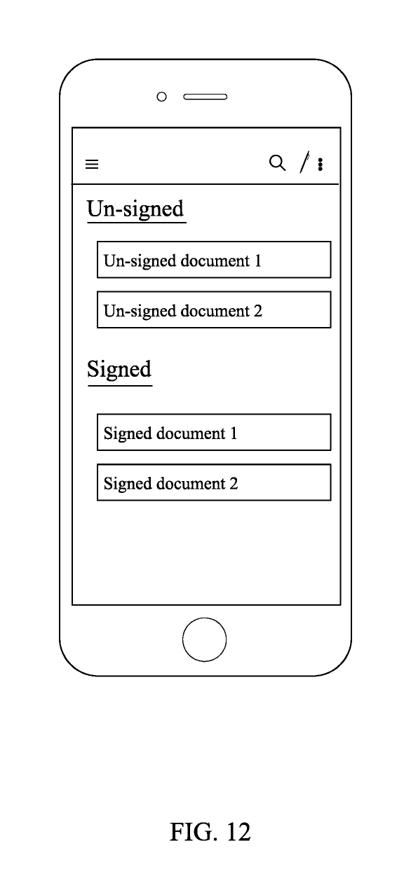

In addition to creating location signed documents, the present invention preferably further comprises the ability to view and manage a plurality of electronic documents. Referring to FIGS. 5 and 12, in one embodiment, the application may display a list of electronic documents on the user interface. A command is then received through the user interface to access a specific document from the list of electronic documents, and the specific document is displayed on the user interface with the document reader software. The list of electronic documents may contain both signed and unsigned documents. Thus, if the list of electronic documents comprises at least one unsigned document, the at least one unsigned document is displayed on the user interface in the list of electronic documents. Similarly, if the list of electronic documents comprises at least one location signed document, the at least one location signed document is displayed on the user interface in the list of electronic documents when the user inputs a command to view the list of electronic documents.

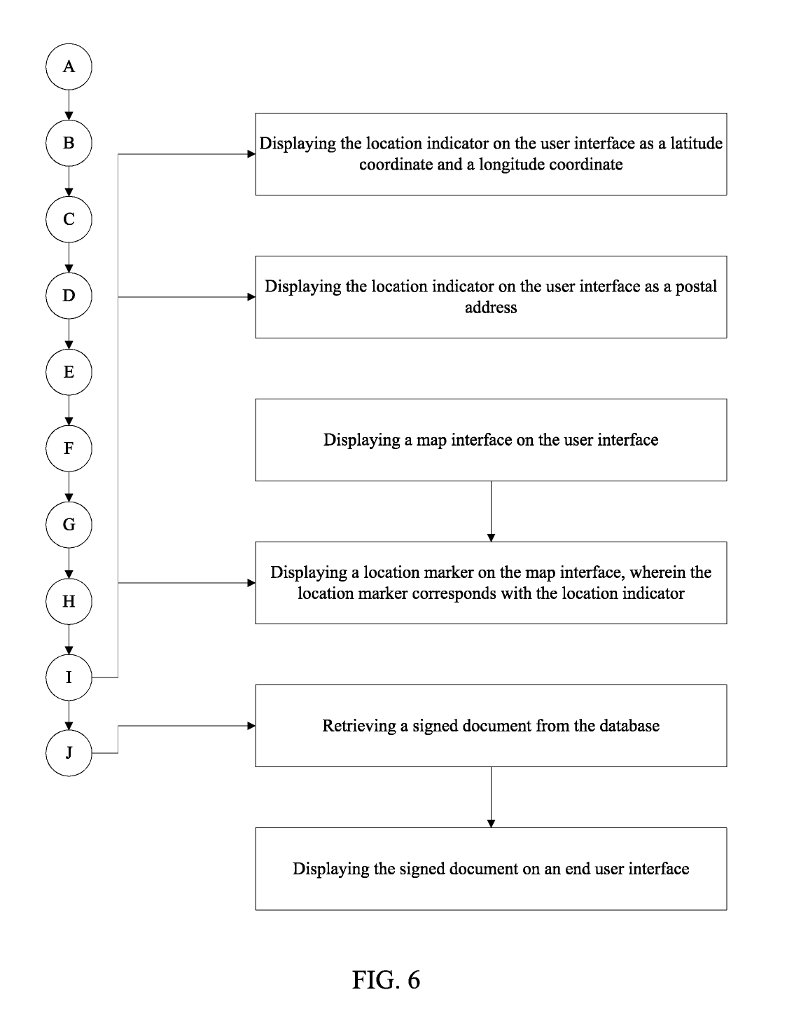

Referring to FIG. 6, the present invention additionally allows an end user to view signed or unsigned documents utilized by the present invention for accountability and validity of the signee, or for other reasons. The end user may be an administrator or other entity who wishes to view a location signed document signed by a specific user, or electronic documents signed in a specific geographical region, or electronic document signed in a specific time frame, or documents sharing other attributes. The end user requests to retrieve a specific signed document from the database and the specific signed document is displayed on an end user interface. The end user interface may be a web portal coupled with management application software, or another type of end user interface.

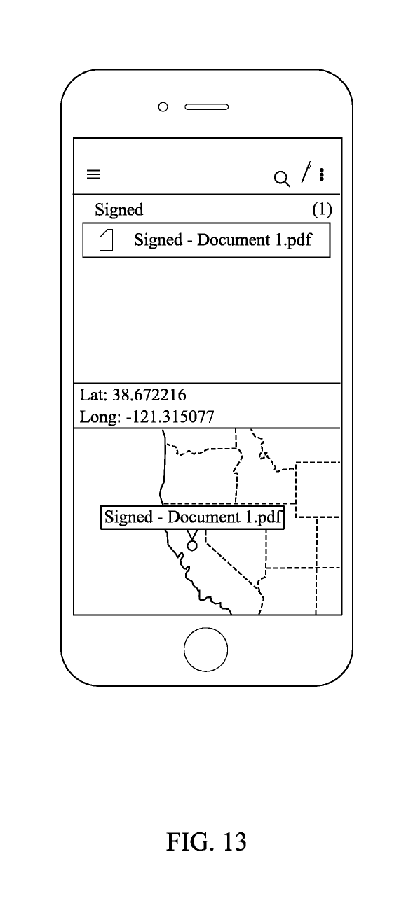

In one embodiment, when the user or end user views a location signed document, the location indicator is displayed on the user interface. In one embodiment, the location indicator is displayed as a latitude coordinate and a longitude coordinate. In another embodiment, the location indicator is displayed as a postal address. There may be an option comprised in the present invention to choose whether the location indicator is displayed as a latitude coordinate and a longitude coordinate, or as a postal address, or both, or as another type of location indicator. Referring to FIG. 13, in one embodiment, a map interface is displayed on the user interface, and a location marker is displayed on the map interface, wherein the location marker corresponds with the location indicator. The location marker serves as a visual aid to the user in ascertaining the location at which an electronic document was signed.

The following is an exemplary description of one embodiment of the present invention, and is not intended to be limiting. As a general description of one embodiment, first a mobile software application activates, triggering a geo-location based signal in real time for each and all electronic signatures performed to sign an electronic document on any mobile GPS enabled handheld device. Second, the geo-location based tracked information is displayed on the mobile device, showing GPS coordinates and/or a physical address to a recipient of after the electronic signature has been performed. Finally, once the electronic signature is received it is then retrieved in the database and on the end user web portal coupled with management application software for accountability and validity of the signee.

It should be noted that in some cases, digital signatures and electronic signatures are referred to and distinguished by the method of inputting the signatures. An electronic signature may be referred to in reference to a hand-drawn signature through a touchscreen or other freehand input device, as illustrated in FIG. 10, and a digital signature may be referred to as a signature that is inputted through a keyboard or other typing means and rendered in a font, as illustrated in FIG. 11. However, it should be understood that both the drawn and typed signatures are both technically digital and electronic, as noted previously.

The present invention comprises of a geo-location based tracking software providing coordinates and/or a physical address in real time to the signee and to the end-user back at headquarters for database management. The present invention also comprises of an electronic signature software application, API-Connectors to other electronic signature solution providers, and a Web Portal and End-User Database Management software.

The steps of the present invention are as follows. First, a person or persons will digitally sign and/or electronically sign a PDF or mobile compatible form document via the smartphone, smartwatch or tablet computing device such as laptops or notebooks. The GPS chip then activates or trigger the geo-location based coordinates and physical address upon receipt of entry of a submit button by the person. The geo-location is then displayed on the mobile handheld device, and back to the end user web portal simultaneously in real time. Second, when a GPS signal is unavailable, geolocation applications can use information from cell towers to triangulate the approximate position, a method that is not as accurate as GPS but has greatly improved in recent years. Finally, the geo-location tracked information is displayed on the mobile handheld device then retrieved in the database on the End User Management application. Geo-location is closely related to the use of positioning systems but may be distinguished from it by a greater emphasis on determining a meaningful location (e.g. a street address) rather than just a set of geographic coordinates.

The components of the present invention are put together by a proprietary mobile software application (embedded code or script) that will be part of a workflow process from within the framework of the proprietary geo-location based coordinate digital signature and electronic signature app and/or web based application developed and built from the ground up to have all functions working together cohesively.

Several additional details of the present invention include Geo-location based Coordinates Digital Signatures and/or Electronic Signatures via public or private wireless network or corporate network transmitted by mobile devices. For signing accuracy, the mobile device renders digital signature and Geo-location based coordinates on the mobile device display in real time when a signal is received from the GPS satellite network and then transmits signals to a GPS receiver. If the mobile carrier network become unavailable, then the mobile device stores GPS location data, date, time, and coordinates latitude longitude in the mobile device on board memory and stores tracking data on the phone until the mobile carrier network becomes available. Once the carrier network is available, the digital signature and/or electronic signature along with coordinates stored in memory will transmit accurate real time data to the management database and append signature Geo-location based to the target document. There is also a notification feature if users have signed outside of specified radius. Based on user role permissions, specified accounts will be designated to view signatures from a geographic map on the web portal. The present invention targets any smart mobile device, including the smartphone, smartwatch or tablet computing device such as laptops or notebooks that utilize GPS along with an operating system. The present invention will also integrate with mobile payment and online payment applications.

The following is an elaboration on each step of the present invention's utilization process. (1) The digital signature and/or electronic signature has been performed on the mobile device. (2) The mobile device transmits signals to a satellite network, then the satellite transmits signals to a GPS receiver on the mobile device. (3) The proprietary mobile software application activates, triggering a global positioning/geo-location based coordinate to the mobile device. (4) Geo-location based tracking software provides coordinates and/or a physical address in real time to the signee on the mobile device and to the end-user back at headquarters for database management. (5) Triangulation is used as a failover method and an option for end user to use cell tower coordinates if line of sight to satellite is blocked, and cell tower addresses are incorporated to the digital signature and/or electronic signature. (6) Once the digital signature and/or electronic signature is received it is then retrieved in the database and on the end user web portal coupled with management application software for accountability and validity of the signee. (7) Providing an API (Application Programming Interface) and middleware connector to offer inoperability to other digital signature and/or electronic signature solution providers. (8) The geo-location based digital signature and/or electronic signature including coordinates, data, time and date is sent to the place of business headquarters that is captured in the Proprietary Management Software and simultaneously sent over to the Data Management Centers and Servers at the designated Co-location sites. (9) The Data Management Centers and Servers are storing and sharing data collected back to company headquarters, customer's place of business and other digital signature and/or electronic signature solution providers.

Although the invention has been explained in relation to its preferred embodiment, it is to be understood that many other possible modifications and variations can be made without departing from the spirit and scope of the invention as hereinafter claimed.

What is claimed is:

1. A method of location based electronic document signature tracking by executing computer-executable instructions stored on a non-transitory computer-readable medium comprises the steps of:
providing a mobile computing device comprising a user interface, a global positioning system (GPS) device, and document reader software;
providing a database;
receiving an electronic document;
retrieving a location indicator through the GPS device;
displaying the electronic document on the user interface with the document reader software;
displaying a signature input field on the user interface;
receiving signature input through the signature input field;
create a location signed document by associating the signature input and the location indicator with the electronic document;
displaying the location indicator on the user interface; and
storing the location signed document in the database.

2. A method of location based electronic document signature tracking by executing computer-executable instructions stored on a non-transitory computer-readable medium as claimed in claim 1 comprises the step of:
retrieving a latitude coordinate and a longitude coordinate through the GPS device as the location indicator.

3. A method of location based electronic document signature tracking by executing computer-executable instructions stored on a non-transitory computer-readable medium as claimed in claim 1 comprises the step of:
triangulating the location indicator through a cellular network, if the location indicator cannot be retrieved from the GPS device.

4. A method of location based electronic document signature tracking by executing computer-executable instructions stored on a non-transitory computer-readable medium as claimed in claim 1 comprises the steps of:
prompting to allow access to the GPS device; and
retrieving the location indicator from the GPS device, if user input is received through the user interface to allow access to the GPS device.

5. A method of location based electronic document signature tracking by executing computer-executable instructions stored on a non-transitory computer-readable medium as claimed in claim 1 comprises the step of:
generating a plurality of metadata attributes;
associating the metadata attributes with the location signed document along with the location indicator;

6. A method of location based electronic document signature tracking by executing computer-executable instructions stored on a non-transitory computer-readable medium as claimed in claim 1 comprises the steps of:
displaying a list of electronic documents on the user interface;
receiving a command through the user interface to access a specific document from the list of electronic documents; and
displaying the specific document on the user interface with the document reader software.

7. A method of location based electronic document signature tracking by executing computer-executable instructions stored on a non-transitory computer-readable medium as claimed in claim 6 comprises the step of:
displaying at least one unsigned document in the list of electronic documents.

8. A method of location based electronic document signature tracking by executing computer-executable instructions stored on a non-transitory computer-readable medium as claimed in claim 6 comprises the step of:
displaying at least one location signed document in the list of electronic documents.

9. A method of location based electronic document signature tracking by executing computer-executable instructions stored on a non-transitory computer-readable medium as claimed in claim 1 comprises the step of:
receiving a drawn signature through the user interface as the signature input, wherein the user interface is a touchscreen.

10. A method of location based electronic document signature tracking by executing computer-executable instructions stored on a non-transitory computer-readable medium as claimed in claim 1 comprises the step of:
receiving a text signature through the user interface as the signature input.

11. A method of location based electronic document signature tracking by executing computer-executable instructions stored on a non-transitory computer-readable medium as claimed in claim 1 comprises the steps of:
retrieving a signed document from the database; and
displaying the signed document on an end user interface.

12. A method of location based electronic document signature tracking by executing computer-executable instructions stored on a non-transitory computer-readable medium as claimed in claim 1 comprises the step of:
displaying the location indicator on the user interface as a latitude coordinate and a longitude coordinate.

13. A method of location based electronic document signature tracking by executing computer-executable instructions stored on a non-transitory computer-readable medium as claimed in claim 1 comprises the step of:
displaying the location indicator on the user interface as a postal address.

14. A method of location based electronic document signature tracking by executing computer-executable instructions stored on a non-transitory computer-readable medium as claimed in claim 1 comprises the steps of:
displaying a map interface on the user interface; and
displaying a location marker on the map interface, wherein the location marker corresponds with the location indicator.
